(19) United States
(12) Patent Application Publication
(10) Pub. No.: US 2012/0112732 A1
(43) Pub. Date: May 10, 2012

(54) Capacitive Impedance Decoupling AC Power Controller

(76) Inventor: Paul Lenworth Mantock, Middlesex (GB)

(21) Appl. No.: 13/381,954

(22) PCT Filed: Jun. 30, 2010
(86) PCT No.: PCT/GB2010/001269

§ 371 Date: Jan. 1, 2012

(30) Foreign Application Priority Data
Jul. 1, 2009 (GB) 0911409.1

(51) Int. Cl. H02M 5/08

(52) U.S. Cl. 323/364

(57) ABSTRACT

A capacitive impedance decoupling AC power controller comprising, a plurality of zero loss capacitors 12 in parallel each of desired capacitance C farads. The plurality of zero loss capacitors in parallel 12 are commonly connected in series to the output AC power supply 10 of Vs volts at frequency f hertz, and to the input to the load 11. A progressive switch 13 is incorporated as a means by which each buffer capacitor of the plurality of zero loss capacitors 12 arranged in parallel is progressively connected to the circuit, increasing the capacitance of the constant voltage AC current controller, thereby increasing the current to the load 11 in the following way,

from, I=2πfCVs to 2πf(2C)Vs and to 2πf(3C)Vs amps, increasing the transmitted current I amps and progressively disconnect by switch 13 each zero loss capacitor arranged in parallel 12, reducing the capacitance of the constant voltage AC current controller in the following way,
from I=2πf(3C)Vs to 2πf(2C)Vs and to 2πfCVs amps, reducing the transmitted current I. The sensitivity of the capacitive impedance decoupling AC power controller can be increase by providing a plurality of sensitivity power control zero loss capacitors 12a of desired lower capacitance values than the capacitance values of the plurality of zero loss capacitors 12, with switch 13a to progressively connect and disconnect each of the plurality of sensitivity power control zero loss capacitors 12a, can be provided in the circuit to increase the sensitivity of the constant voltage current controller for each setting of the plurality of capacitors 12 so that the desired current to the load 11 can be achieved.

### CROSS-REFERENCE TO RELATED APPLICATION

This application claims priority date of Patent Application No. 1011053.4 (GB) filed 2009 Jul. 1 by the present inventor.

### FEDERALLY SPONSERED RESEARCH

Not Applicable

### SEQUENCE LISTING OR PROGRAM

Not Applicable

### BACKGROUND OF INVENTION

### Field Of Invention

To control AC electric power to a load, to have the load perform in some desirable way, perhaps to control light levels or to control the speed of an induction motor, has been achieved by various means. AC electric power has been controlled by varying voltage and current by the use of resistance or a combination of resistance and electronics. The use of resistance to control electric power to a load is simple, it reduces the power to the load by converting some power to heat energy. Though simple, it's wasteful. The variac is relatively simple, it controls the voltage across to the load thereby controlling the power to the load. Though relatively simple, is not as wasteful as resistance control, but is bulky and heavy, which makes it unsuitable for many power controlling applications. The use of electronics to periodically switch on and off the power supply, controlled by means of varying the resistance, controls the power to the load. It is not as wasteful as purely resistance based control or as bulky and heavy as a variac has complex electronics and can adversely affect the smooth running of an induction motor, when used as a means to control its speed. Any control system involving resistance has to be power matched to the load. If the power rating of a resistive control is lower than that of the load, the control will be overloaded and fail, because the load will take the power required by its power rating.

Larger induction motors use frequency control as a means to control speed, but the voltage change across the motor has to be integrated with the change of frequency to control the speed of the motor. This gives the motor very smooth control, but it requires complex electronics. It is well known that as the complexity of anything increases, it becomes more expensive and also increases it chances of failure. And any power control that involves a change of frequency can generate harmonics frequencies in the load, the power supply and or the power control, because each of these equipment have capacitance and inductance which are coupled. The interaction of the capacitance and inductance in these equipment causes harmonic frequencies, which can cause damage to the load, the power control and or the power supply equipment.

What is needed is a simple but effective way of controlling the power supply to the load, by controlling the current to the load and or the voltage across the load without resistance and inductance. This will eliminating resistance losses and harmonics frequencies from being developed by decoupling the power supply, power control and the load so that generated frequencies in each will not interact with each other, preventing harmonic frequencies being developed.

An impedance component such as a capacitor has an impedance Z ohms where,

Z=√R²+(2πfL−½πfC)² ohms,

A current I amps transmitted through a conventional capacitor is given by the relationship, I=V/Z where V is the voltage drop across the capacitor, C farads is the capacitance of the capacitor, R ohms its resistance and L henrys its inductance.

A purely capacitive impedance component, such as a zero loss capacitor, has zero resistance and inductance, therefore it has an impedance Z. ohms, where,

Z=2πfC ohms

The current I amps being transmitted through a zero loss capacitor is given by the relationship I=V/Z, but when connected in series to an AC power supply of voltage Vs volts, there is zero voltage drop V volts across the capacitor since its resistance and inductance are zero, the current I being transmitted through it is then,

I=Vs/Z=2πfCVs amps

The zero loss capacitor will only transmit current strictly according to its impedance since the frequency and voltage of a power supply are constant. By varying the capacitance of the impedance of the relationship I=2πfCVs amps, the current to load can be varied, controlling the power to the load.

For harmonic frequency f hertz for different frequencies to develop then the following relationship,

f=½π√LC,

has to be satisfied for each harmonic frequency. The zero loss capacitor has zero inductance, therefore that condition cannot be satisfied, therefore the zero loss capacitor creates a barrier to harmonics frequencies, thereby decoupling the power supply the power control and the load.

The present invention relates to a capacitive impedance decoupling AC power controller, and in a first embodiment of the invention the capacitive impedance decoupling AC power controller comprises a number of purely capacitive impedance components in the form of zero loss capacitors, connected in parallel and provided with a switch to progressively connect and disconnect each of the zero loss capacitors to give the desired current, thereby controlling the power to the load.

In a second embodiment of the invention, the capacitive impedance decoupling AC power controller comprises a plurality of zero loss capacitors, each with set values of capacitance, to give the desired value of current to the load. A selector switch is provided to select the desired value of capacitance to give the desired current to the load, thereby controlling the current to the load.

In a third embodiment of the invention the capacitive impedance decoupling AC power controller comprises a plurality of zero loss capacitors in series. A switch is provided to progressively connect and disconnect each zero loss capacitor in series, varying the capacitance, which varies the voltage across the load and the current to the load, according to capacitor in series theory, thereby controlling the power to the load.

The sensitivity of each embodiment of the capacitive impedance decoupling AC power controller can be increased by providing in each circuit a plurality of sensitivity power control zero loss capacitors of values that reflects the desired sensitivity. An appropriate switch can be provided to progressively connect and disconnect each sensitivity power control zero loss capacitors or to select a sensitivity power control zero loss capacitor, to give the capacitance to give the desired current, thereby controlling the sensitivity of the power to the load.

A zero loss capacitor has no resistance, therefore all losses associated with resistance controls will be eliminated. It also has zero inductance therefore all losses associated with inductance will be eliminated and its zero inductance will prevent harmonic frequencies from being developed, by being a barrier to inductive components of impedance, decoupling the power supply, the power controller and the load, thereby preventing harmonic frequencies from being developed by the interaction of frequencies developed in the power supply, the power controller and the load. It is a simpler control systems therefore all problems associated with electronic controls such as the triacs or silicon-control rectifiers will be eliminated, resulting in a more simple, efficient and reliable AC power control.

The capacitive impedance decoupling AC power controller is explained by the following schematic drawings:

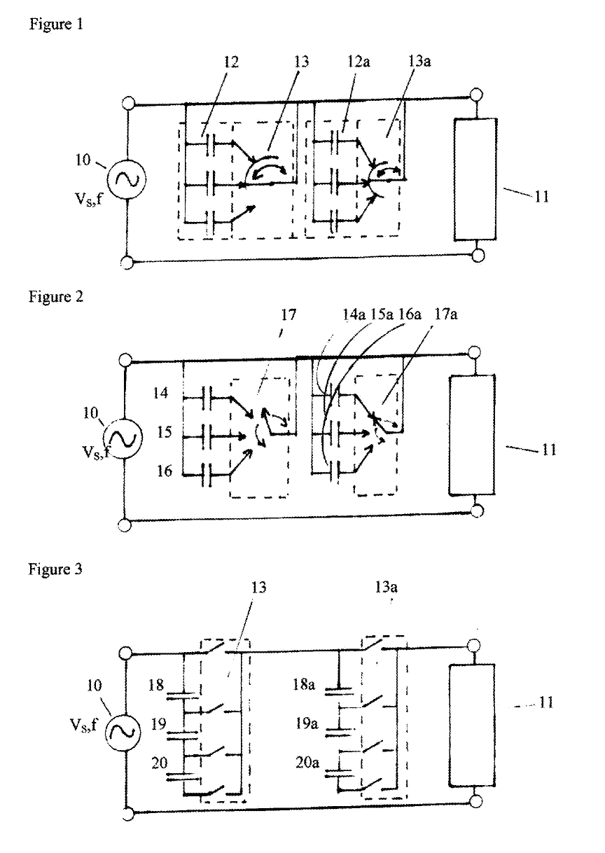

FIG. 1 shows the schematic drawing of the first embodiment of the capacitive impedance decoupling AC power controller.

FIG. 2 shows the schematic drawing of the second embodiment of the capacitive impedance decoupling AC power controller.

FIG. 3 shows the schematic drawing of the third embodiment of the capacitive impedance decoupling AC power controller.

FIG. 1 shows the first embodiment the capacitive impedance decoupling AC power controller comprising, a plurality of zero loss capacitors 12 in parallel each of desired capacitance C farads. The plurality of zero loss capacitors in parallel 12 are commonly connected in series to the output AC power supply 10 of Vs volts at frequency f hertz, and to the input to the load 11. A progressive switch 13 is incorporated as a means by which each zero loss capacitor of the plurality of zero loss capacitors 12 arranged in parallel is progressively connected to the circuit, increasing the capacitance of the constant voltage AC current controller, thereby increasing the current to the load 11 in the following way,

from, I=2πfCVs to 2πf(2C)Vs and to 2πf(3C)Vs amps,
increasing the transmitted current I amps and progressively disconnect by switch 13 each zero loss capacitor arranged in parallel 12, reducing the capacitance of the constant voltage AC current controller in the following way,
from I=2πf(3C)Vs to 2πf(2C)Vs and to 2πfCVs amps,
reducing the transmitted current I. The sensitivity of the capacitive impedance decoupling AC power controller can be increase by providing a plurality of sensitivity power control zero loss capacitors 12a of desired lower capacitance values than the capacitance values of the plurality of zero loss capacitors 12, with switch 13a to progressively connect and disconnect each of the plurality of sensitivity power control zero loss capacitors 12a, can be provided in the circuit to increase the sensitivity of the constant voltage current controller for each setting of the plurality of capacitors 12 so that the desired current to the load 11 can be achieved.

FIG. 2 shows the second embodiment of the invention, where the capacitive impedance decoupling AC power controller comprises a plurality of zero loss capacitors 14, 15 and 16 electrically connected to the load 11 and power supply 10, each with set values of capacitance C₁₄, C₁₅ and C₁₆ farads respectively to give the desired value of current to the load 11 in each case. A selector switch 17 is provided to select the desired value of capacitance from the set values of zero loss capacitors C₁₄, C₁₅ and C₁₆ farads, to give the desired current to the load 11, thereby controlling the power to the load 11. The sensitivity of the capacitive impedance decoupling AC power controller in this embodiment of the invention is increased by providing in the circuit a plurality of sensitivity power control zero loss capacitors 14a, 15a and 16a with desired capacitance values C₁₄ₐ, C₁₅ₐ and C₁₆ₐ, which can be lower than the capacitance values of the plurality of zero loss capacitors 14, 15 and 16 each with set values of capacitance C₁₄, C₁₅ and C₁₆ farads respectively. The plurality of sensitivity power control zero loss capacitors 15a, 16a and 17a are provided with a switch 17, so that the capacitance of each of the set values of capacitance C₁₄, C₁₅ and C₁₆ farads respectively can be varied can be provided to increase the sensitivity of the capacitive impedance decoupling AC power controller for each of set values of zero loss capacitors 14, 15 and 16, so that the desired current to the load 11 can be achieved in each case.

FIG. 3 shows the third embodiment of the invention, where the capacitive impedance decoupling AC power controller comprises, a plurality of zero loss capacitors 18, 19 and 20 of capacitance C₁₈, C₁₉ and C₂₀ farads respectively, in series and connected to a power supply 10 and a load 11. The capacitance C₁₈ of the first zero loss capacitor 18 in the zero has to be a value to transmit a current that will give the load maximum required power. And a progressive switch 13 is provided to progressively connect and disconnect each zero loss capacitor 18, 19 and 20 in series, progressively reducing and increasing the capacitance, according to capacitor in series theory, whereby the total capacitance C_{T} farads to the load 11, varies in the following way,

C_{T}=C₁₈,C_{T}=C₁₈C₁₉/C₁₈+C₁₉ and C_{T}=C₁₈C₁₉C₂₀/C₁₈+C₁₉+C₂₀ farads,

which varies the current to the load 11. This embodiment is can be provided in the circuit, a plurality of sensitivity power zero loss capacitor 18a, 19a and 20a arranged in parallel and provided with a switch 13a o progressively connect and disconnect the plurality of sensitivity power zero loss capacitors 18a, 19a and 20a, with capacitance C₁₈ₐ, C₁₉ₐ and C₂₀ₐ varying the capacitance, hence varying the current, thereby controlling the sensitivity of the power to the load 11.

1. A capacitive impedance decoupling AC power controller comprising,
a plurality of capacitive impedance components arranged in parallel combinations of desired capacitance and the said plurality of capacitive impedance components arranged in parallel combinations and being provided with the means to be connected in series to load and an AC power supply
and the said plurality of capacitive impedance components arranged in parallel combinations being provided with a progressive switch as means to progressively connect and disconnect the said plurality of capacitive impedance components arranged in parallel combinations as means to vary the capacitance of the said plurality of capacitive impedance components arranged in parallel combination, varying the current to the load, thereby varying the power to the load
and the said plurality of capacitive impedance components arranged in parallel combinations being provided with a plurality of sensitivity power control capacitive impedance components of desired capacitance arranged in parallel combinations and the said plurality of sensitivity power control capacitive impedance components being provided with a progressive switch as means to progressively connect and disconnect each of the said plurality of sensitivity power control capacitive impedance components, so that the sensitivity of each variation of the said plurality of capacitive impedance components arranged in parallel combinations can be increased, increasing the sensitivity of control of the current for each variation of the said plurality of capacitive impedance components arranged in parallel combinations, thereby increasing the sensitivity of control of power to the load
and the said plurality of capacitive impedance components and the said plurality of sensitivity control power control capacitive impedance components, both having zero inductance, acting as a barrier, decoupling the power supply from the load, thereby preventing harmonic frequencies from being developed in the power supply and the load.

2. A capacitive impedance decoupling AC power controller comprising,
a plurality of capacitive impedance components and each of the said capacitive impedance components of desired capacitance and the said plurality of capacitive impedance components being provided with the means to be connected in series to load and an AC power supply
and the said plurality of capacitive impedance components being provided with a selective switch to selectively connect and disconnect each the said plurality of capacitive impedance components, as means to connect and disconnect each of the selected of the said plurality of capacitive impedance components, selecting the desired capacitive impedance component, selecting current to the load, thereby selecting the power to the load
and the said plurality of capacitive impedance components being provided with a plurality of sensitivity power control capacitive impedance components of desired capacitance, arranged in the circuit and provided with a selective switch so that the sensitivity of each of the selected said plurality of capacitive impedance components can be selectively increased and decreased, increasing the sensitivity of current for each selection of the said plurality of capacitive impedance components, increasing the sensitivity of the current to the load, thereby increasing the sensitivity of control of power to the load
and the said plurality of capacitive impedance components and the said plurality of sensitivity control power control capacitive impedance components, both having zero inductance, acting as a barrier, decoupling the power supply from the load, thereby preventing harmonic frequencies from being developed in the power supply and the load.

3. A capacitive impedance decoupling AC power controller comprising,
a plurality of capacitive impedance components arranged in series combinations of desired capacitance and the said plurality of capacitive impedance components arranged in series combinations and being provided with the means to be connected in series to load and an AC power supply
and the said plurality of capacitive impedance components arranged in series combinations being provided with a switch to progressively connect and disconnect the said plurality of capacitive impedance components arranged in series combinations as means to vary the capacitance of the said plurality of capacitive impedance components arranged in series combination, varying the current to the load according to capacitance series capacitive relationship, thereby varying the power to the load
and the said plurality of capacitive impedance components arranged in series combinations being provided with a plurality of sensitivity power control capacitive impedance components arranged in series combinations of desired capacitance, arranged in the circuit and provided with a switch, so that the sensitivity of each variation of the said plurality of capacitive impedance components arranged in series combinations can be increased, increasing the sensitivity of current for each variation of the said plurality of capacitive impedance components arranged in series combinations, increasing the sensitivity of the current to the load, thereby increasing the sensitivity of control of power to the load
and the said plurality of capacitive impedance components arranged in series and the said plurality of sensitivity power control capacitive impedance components arranged in series, acting as a barrier, decoupling the power supply from the load, thereby preventing harmonic frequencies from being developed in the power supply and the load.

4. A capacitive impedance decoupling AC power controller as in claim 1 claim 2 and claim 3 wherein,
the said plurality of capacitive impedance components is provided with a switch as means to vary the capacitance of the plurality of capacitive impedance components, varying the current, thereby varying the power to the load.

5. A capacitive impedance decoupling AC power controller as in claim 1 claim 2 and claim 3 wherein,
the said plurality of sensitivity power control capacitive impedance components is provided with a switch as means to increase the sensitivity of the control of the current to the load, thereby increasing the sensitivity of the power to the load.

6. A capacitive impedance decoupling AC power controller as in claim 1, claim 2 and claim 3 wherein the said plurality of capacitive impedance components with zero inductance, acts as a barrier to inductive and capacitive interactions, decoupling the power supply and the load, thereby eliminating the development of harmonic frequencies.

7. A capacitive impedance decoupling AC power controller as in claim 1, claim 2 and claim 3 wherein the said plurality of sensitivity power control capacitive impedance components with zero inductance, acts as a barrier to inductive and capacitive interactions, decoupling the power supply and the load, thereby eliminating the development of harmonic frequencies.
